(19) United States
(12) Patent Application Publication
(10) Pub. No.: US 2009/0046701 A1
(43) Pub. Date: Feb. 19, 2009

(54) RADIO COMMUNICATION BASE STATION APPARATUS AND SYNCHRONIZATION CHANNEL SIGNAL TRANSMISSION METHOD

(75) Inventors: Akihiko Nishio, Kanagawa (JP); Hidetoshi Suzuki, Kanagawa (JP); Isamu Yoshii, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaks (JP)

(21) Appl. No.: 12/160,194

(22) PCT Filed: Jan. 12, 2007
(86) PCT No.: PCT/JP2007/050339

§ 371 Date: Jul. 7, 2008

(30) Foreign Application Priority Data
Jan. 13, 2006 (JP) 2006-005781

(51) Int. Cl. H04J 3/06

(52) U.S. Cl. 370/350

(57) ABSTRACT

Provided is a base station capable of searching cells of different frequencies without losing a opportunity of data communication by effectively performing SCH data transmission. The base station (100) includes: an encoding unit (101) for encoding SCH data; a modulation unit (102) for modulating the encoded SCH data; a transmission timing setting unit (103) for setting the transmission timing of the SCH data; encoding units (104-1 to 104-N) for encoding user data (#1 to #N), modulation units (105-1 to 105-N) for modulating the encoded user data (#1 to #N); and an IFFT unit (106) for mapping the SCH data and the user data (#1 to #N) to sub carriers (#1 to #K) and performing IFFT to generate an OFDM symbol. The transmission timing setting unit (103) sets the transmission timing of the SCH data so that, for example, the SCH data transmission cycle and the frame cycle are relatively prime, i.e., the maximum common multiple of them is 1.

### TECHNICAL FIELD

The present invention relates to a radio communication base station apparatus and a synchronization channel signal transmission method.

### BACKGROUND ART

In recent years, in radio communication, particularly in mobile communication, various kinds of information such as images and data as well as speech are subjected to transmission. From now on, it is expected that demands further increase for transmitting various types of content, and it naturally follows that the need for high speed transmission is expected to further increase. However, when high speed transmission is performed in mobile communication, the influence of delayed waves by multipath is not negligible, and transmission performance degrades due to frequency selective fading.

Multicarrier communication such as OFDM (Orthogonal Frequency Division Multiplexing) is focused as one of counter techniques of frequency selective fading. Multicarrier communication is a technique of performing high speed transmission by transmitting data using a plurality of carriers (subcarriers) of transmission rates suppressed to such an extent that frequency selective fading does not occur. Particularly, the OFDM scheme utilizes a plurality of subcarriers orthogonal to each other where data is arranged, provides high frequency efficiency in multicarrier communication, can be implemented with relatively simple hardware, is particularly focused and is variously studied.

At present, according to the LTE standardization of 3GPP, adopting the OFDM scheme as the downlink communication scheme is studied. With OFDM in the downlink, user data and control data for a plurality of radio communication mobile station apparatuses (hereinafter “mobile stations”) are frequency-domain-multiplexed or time-domain-multiplexed and transmitted from radio communication base station apparatuses (hereinafter “base stations”) to mobile stations.

As a method of transmitting control data in OFDM on downlink, it is suggested to transmit SCH (synchronization channel) data at fixed timing (e.g., the tail end of a frame) using a fixed bandwidth (e.g., 1.25 MHz) (see Non-Patent Document 1).

Here, the SCH is a common channel in the downlink direction and comprised of a P-SCH (primary synchronization channel) and an S-SCH (secondary synchronization channel). P-SCH data contains a sequence which is common in all cells and used for a timing synchronization upon a cell search. Further, S-SCH data contains cell-specific transmission parameters such as scrambling code information. In a cell search upon power activation and upon handover, each mobile station finds a timing synchronization by receiving P-SCH data and acquires transmission parameters that differ per cell by receiving S-SCH data. By this means, each mobile station can start communicating with base stations. Therefore, each mobile station needs to detect SCH data upon power activation and upon handover.

As described above, a mobile station needs to detect SCH data upon power activation, and, moreover, upon handover. In asynchronous mobile communication systems, the transmission timing for SCH data differs per base station (i.e., per cell), and, consequently, a mobile station needs to detect SCH data transmitted from a base station for handover to synchronize with the base station for handover.

Here, when the mobile station performs handover with base station BS2 having a different frequency band (hereinafter “band”) from the band for base station BS1 communicating with the mobile station, as shown in FIG. 1, a cell search is performed in the measurement gap (MG) set by base station BS1 to detect SCH data transmitted from base station BS2 for handover. Thus, a cell search performed in a different band from the band communicating with the mobile station is referred to as a “different-frequency cell search.” The measurement gap is a period in which data transmission stops between a base station and a mobile station, that is, the measurement gap is also referred to as a “non-transmission period.” The mobile station performs a different-frequency cell search in the measurement gap. Therefore, while user data is received from BS1, the mobile station needs to detect SCH data by switching reception frequency from the band for BS1 to the band for BS2, and, after that, restart receiving user data by switching the reception frequency from the band for BS2 to the band for BS1. This switching of reception frequency requires about one subframe of time, and, consequently, the detection time is also taken into consideration and the measurement gap is set over a period of three subframes.

A communication system where a frame is 10 ms and comprised of 20 subframes, will be assumed and explained below. Further, in the frame, SCH data is transmitted by one of subframes. Further, for example, above BS1 is a base station that is provided in the 800 MHz band of a macro cell and performs mobile communication, and above BS2 is a base station that is provided in the 2 GHz band or 2.6 GHz band of a micro cell set as a hot spot or the like in part of this macro cell and performs high speed communication.

Conventionally, a measurement gap is periodically set, that is, a measurement gap is set in a fixed manner in arbitrary subframes in a frame. For example, in FIG. 1, a measurement gap is set in a fixed manner in subframes #3 to #5 in all frames. Here, subframes in which a measurement gap is set may differ per mobile station.

Non-Patent Document 1: 3GPP PAN WG1 LTE Ad Hoc meeting (2005.06) R1-050590

### DISCLOSURE OF INVENTION

### Problems to be Solved by the Invention

However, when a measurement gap is set in a fixed manner as described above, if SCH data is transmitted at fixed timing as is conventionally done, a mobile station may fail to perform a different-frequency cell search in the measurement gap. For example, as shown in FIG. 2, although the measurement gap in BS1 is set in a fixed manner in subframes #3 to #5 in all frames, if SCH data is transmitted from BS2 in subframe #6 in all frames, a mobile station cannot detect the SCH data from BS2 in the measurement gap in all frames in BS1 and perform a different-frequency cell search.

To solve the above problem, as shown in FIGS. 3 to 5, the measurement gap of BS1 is assumed to be moved by one subframe every frame. For example, the measurement gap in frame #1 is set in subframes #3 to #5 (FIG. 3), the measurement gap in frame #2 is set in subframes #4 to #6 (FIG. 4) and the measurement gap in frame #3 is set in subframes #5 to #7 (FIG. 5). By this means, a mobile station can reliably detect SCH data per twenty frames at a maximum.

However, if the above method is employed, the following problems occur. That is, if the measurement gap is moved as above, a mobile station cannot perform data communication with subframe #5 in frames #1, #2 and #3 (FIGS. 3, 4 and 5).

Therefore, when the frame format in BS1 is fixed as shown in FIG. 6, a mobile station performing a different-frequency cell search loses the opportunity to receive MBMS (Multimedia Broadcast/Multicast Service) data, resulting in deteriorating MBMS service quality. MBMS communication is not one-to-one communication but is one-to-many communication, and, consequently, a base station that performs MBMS transmits a same data (such as music data and moving image data) to a plurality of mobile stations at the same time. As MBMS, for example, traffic information distribution, music distribution, news reporting and sports broadcast are studied. For example, in MBMS, as shown in FIG. 6, all mobile stations that communicate with BS1 receive the same MBMS data in subframe #5, and, consequently, even if the number of mobile stations that communicate with BS1 increases, subframes for MBMS data need not to be added. Therefore, the frame format shown in FIG. 6, in which only one subframe in a frame is used for MBMS data and the other nineteen subframes are used for dedicated data of each mobile station, needs to be studied sufficiently. Further, if the frame format in BS1 is fixed as shown in FIG. 7 (DL: downlink data, UL: uplink data), a mobile station performing a different-frequency cell search loses the opportunity to transmit uplink data. Recently, for example, more and more music data and moving image data are downloaded to mobile stations, and, consequently, the frame format shown in FIG. 7, in which only one subframe in a frame is used on uplink and the other nineteen subframes are used on downlink, needs to be studied sufficiently. Here, during this downloading, a mobile station needs to transmit control data to BS1. As a result, if a mobile station loses the opportunity to transmit uplink data, the mobile station cannot even receive downlink data.

It is therefore an object of the present invention to provide a base station and a SCH data transmission method that solve the above problems and can transmit SCH data efficiently.

### Means for Solving the Problem

The base station of the present invention employs a configuration having: a setting section that sets a transmission timing for a synchronization channel signal in one of a plurality of subframes forming a frame; and a transmitting section that transmits the synchronization channel signal at the transmission timing set in the setting section, and in which the setting section changes over time, a subframe in which the transmission timing is set in the plurality of subframes.

### ADVANTAGEOUS EFFECT OF THE INVENTION

According to the present invention, it is possible to transmit SCH data (synchronization channel signal) efficiently and perform a different-frequency cell search without losing the opportunity to perform data communication.

### BRIEF DESCRIPTION OF DRAWINGS

FIG. 1 illustrates a conventional SCH data transmission method;

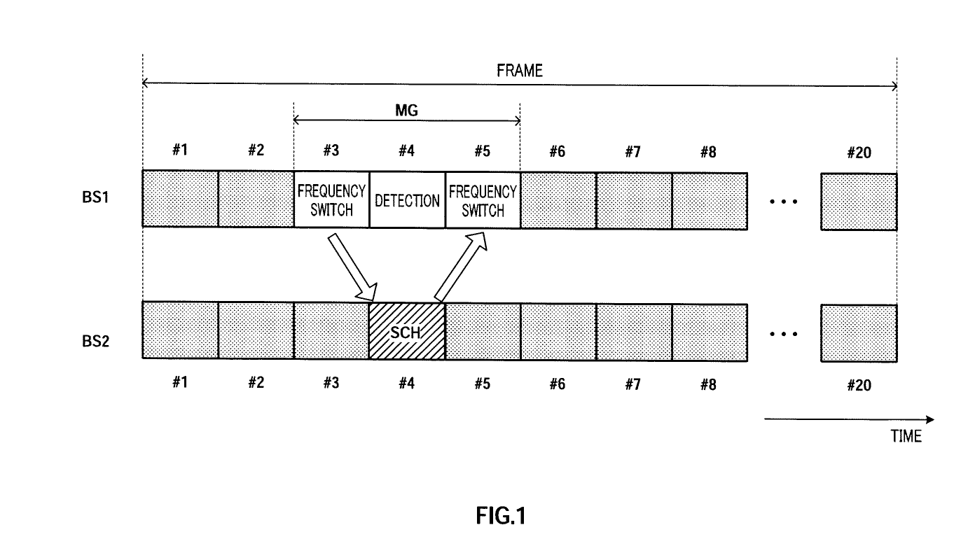

FIG. 2 illustrates an example of a problem with respect to the conventional SCH data transmission method;

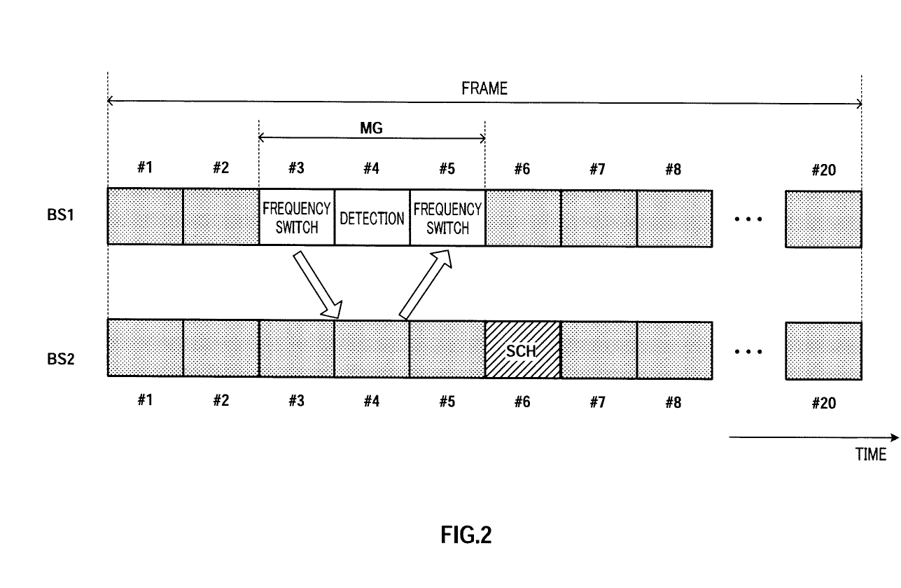

FIG. 3 illustrates an example of solving a problem with respect to a conventional SCH data transmission method is solved (frame #1);

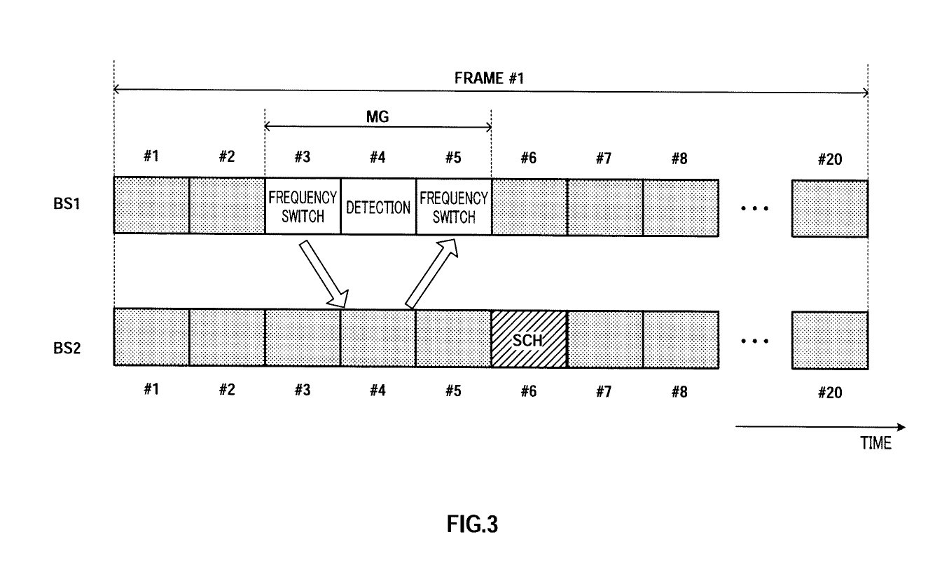

FIG. 4 illustrates an example of solving a problem with respect to a conventional SCH data transmission method (frame #2);

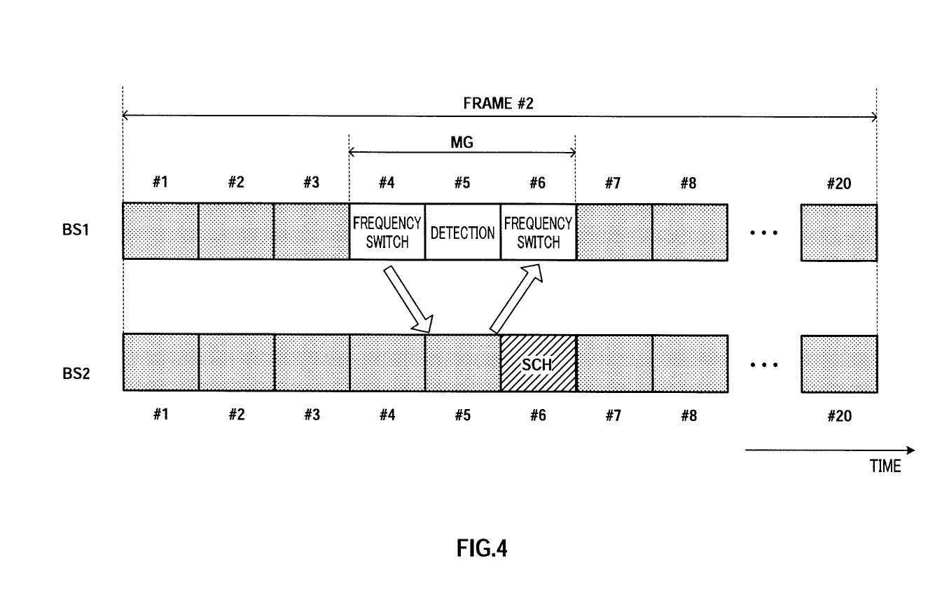

FIG. 5 illustrates an example of solving a problem with respect to a conventional SCH data transmission method is solved (frame #3);

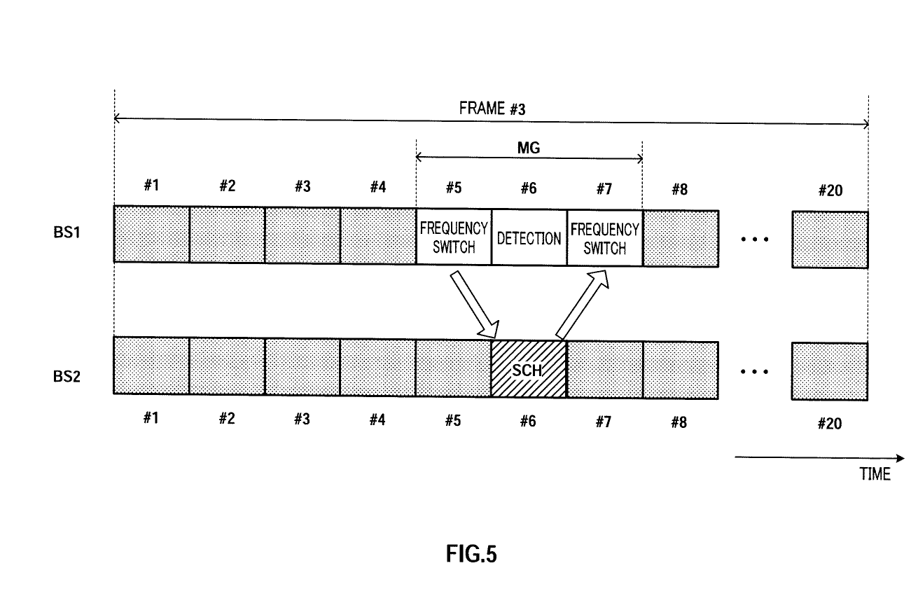

FIG. 6 illustrates an example of a conventional frame format (frame format example 1);

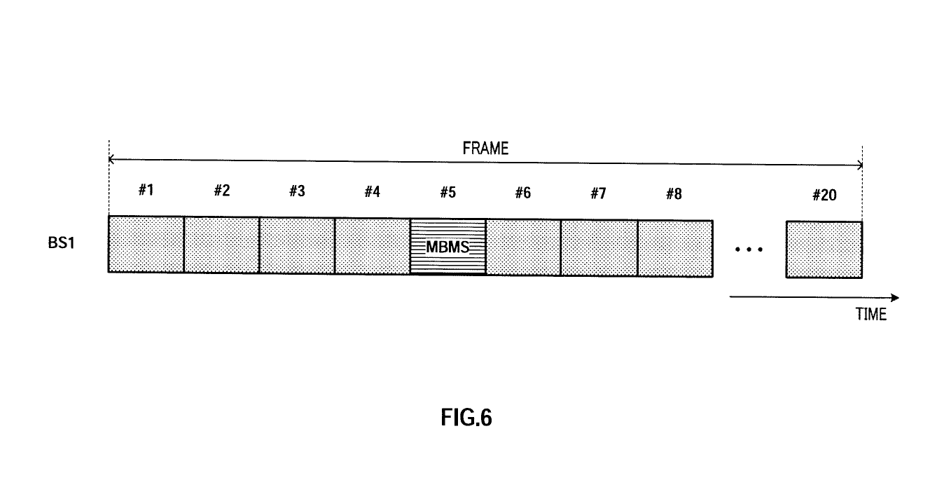

FIG. 7 illustrates an example of a conventional frame format (frame format example 2);

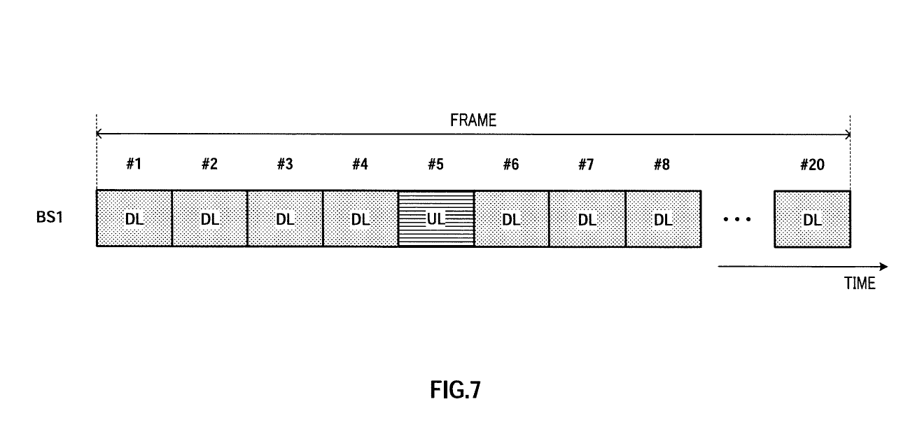

FIG. 8 is a block diagram showing a configuration of a base station according to Embodiment 1 of the present invention;

FIG. 9 illustrates an example of transmission timing setting according to Embodiment 1 of the present invention (setting example 1);

FIG. 10 illustrates an example of SCH data detection according to Embodiment 1 of the present invention (frame #1);

FIG. 11 illustrates an example of SCH data detection according to Embodiment 1 of the present invention (frame #2);

FIG. 12 illustrates an example of SCH data detection according to Embodiment 1 of the present invention (frame #3);

FIG. 13 illustrates an example of transmission timing setting according to Embodiment 1 of the present invention (setting example 2);

FIG. 14 illustrates an example of transmission timing setting according to Embodiment 1 of the present invention (setting example 3);

FIG. 15 is a block diagram showing a configuration of a base station apparatus according to Embodiment 2 of the present invention; and

FIG. 16 illustrates an example of transmission timing setting according to Embodiment 2 of the present invention.

### BEST MODE FOR CARRYING OUT THE INVENTION

Embodiments of the present invention will be explained below in detail with reference to the accompanying drawings. Here, the present invention relates to above BS2. That is, the present invention relates to a base station that transmits SCH data to mobile stations and that is a target for a different-frequency cell search. Further, although an OFDM scheme is explained as an example of a multicarrier communication scheme in the following explanation, the present invention is not limited to the OFDM scheme.

### Embodiment 1

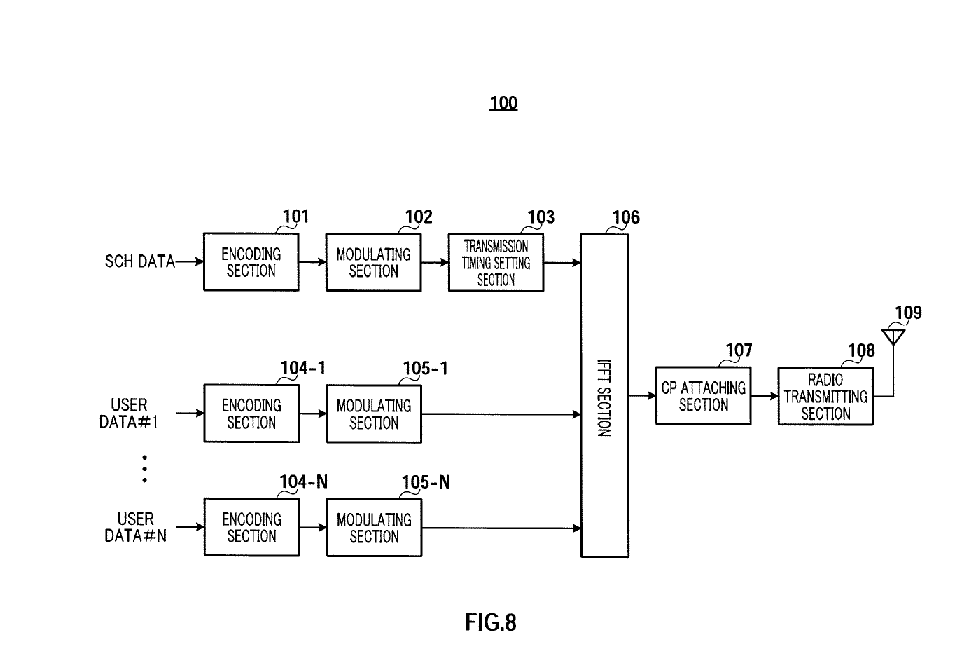

FIG. 8 illustrates a configuration of base station 100 according to the present embodiment.

Encoding section 101 encodes SCH data.

Modulating section 102 modulates the encoded SCH data.

Transmission timing setting section 103 sets the transmission timing for the SCH data. This transmission timing setting will be described later in detail.

Encoding sections 104-1 to 104-N and modulating sections 105-1 to 105-N are provided for mobile stations #1 to #N to which base station 100 transmits user data.

Encoding sections 104-1 to 104-N encode user data #1 to #N, respectively.

Modulating sections 105-1 to 105-N modulate the encoded user data #1 to #N, respectively.

IFFT section 106 generates an OFDM symbol by mapping the SCH data and user data #1 to #N in subcarriers #1 to #K and performing an IFFT (Inverse Fast Fourier Transform).

The OFDM symbol generated as above is attached a cyclic prefix in CP attaching section 107, subjected to predetermined radio processing such as up-conversion in radio transmitting section 108 and transmitted by radio from antenna 109 to mobile stations #1 to #N.

Next, transmission timing setting will be explained in detail.

Transmission timing setting section 103 sets the transmission timing for SCH data in one of a plurality of subframes forming one frame. Therefore, by this transmission timing setting, radio transmitting section 108 transmits the OFDM symbol including SCH data at the transmission timing set in transmission timing setting section 103. Further, in the following explanation, as described above, assume that one frame is comprised of twenty subframes. Setting examples 1 to 3 will be explained below. In setting examples 1 to 3, transmission timing setting section 103 changes every frame, the subframe in which the transmission timing for SCH data is set among subframes #1 to #20. That is, transmission timing setting section 103 periodically changes over time, the subframe in which the transmission timing for SCH data is set.

### Setting Example 1

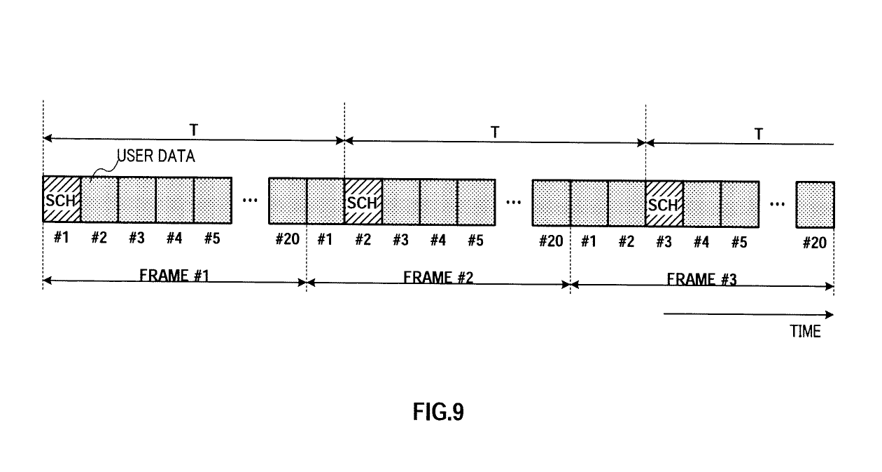

As shown in FIG. 9, transmission timing setting section 103 sets subframe #1 in frame #1, subframe #2 in frame #2 and subframe #3 in frame #3 as the transmission timing for SCH data. That is, transmission timing setting section 103 moves the subframe, in which the transmission timing for SCH data is set among subframes #1 to #20, one subframe backward every frame. By this setting, while the frame cycle is twenty subframes, transmission cycle T for SCH data is twenty-one subframes.

Further, transmission timing setting section 103 may move the subframe, in which the transmission timing for SCH data is set, one subframe forward every frame. In this setting, while the frame cycle is twenty subframes, transmission cycle T for SCH data is nineteen subframes.

As described above, transmission timing setting section 103 sets the transmission timing for SCH data such that the transmission cycle for SCH data and the frame cycle are coprime, that is, transmission timing setting section 103 sets the transmission timing for SCH data such that the greatest common factor between these cycles is 1.

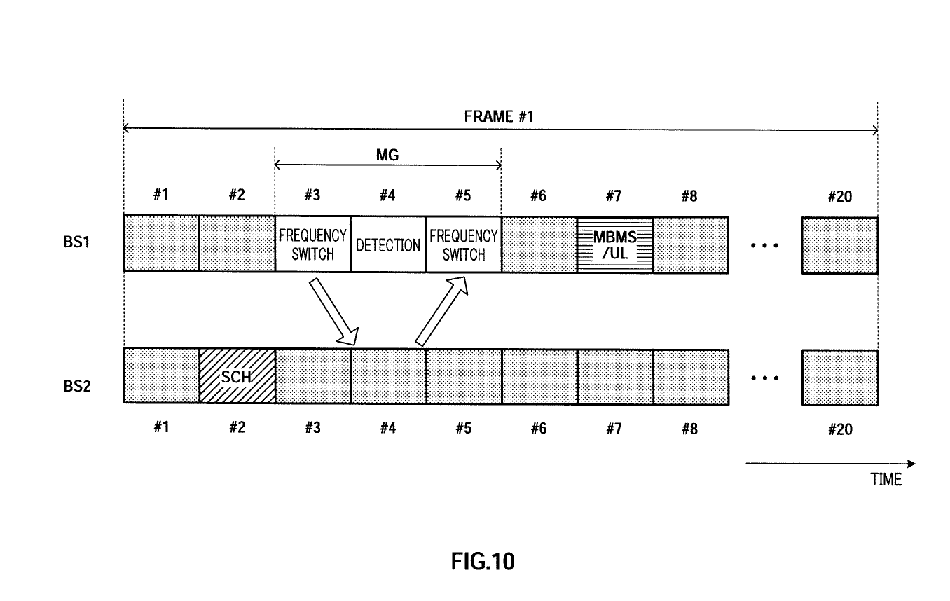

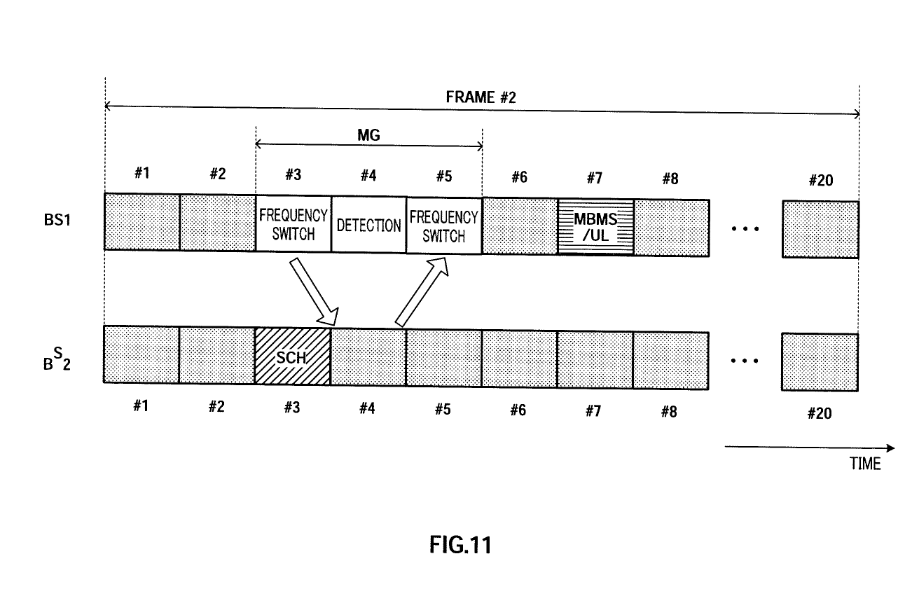

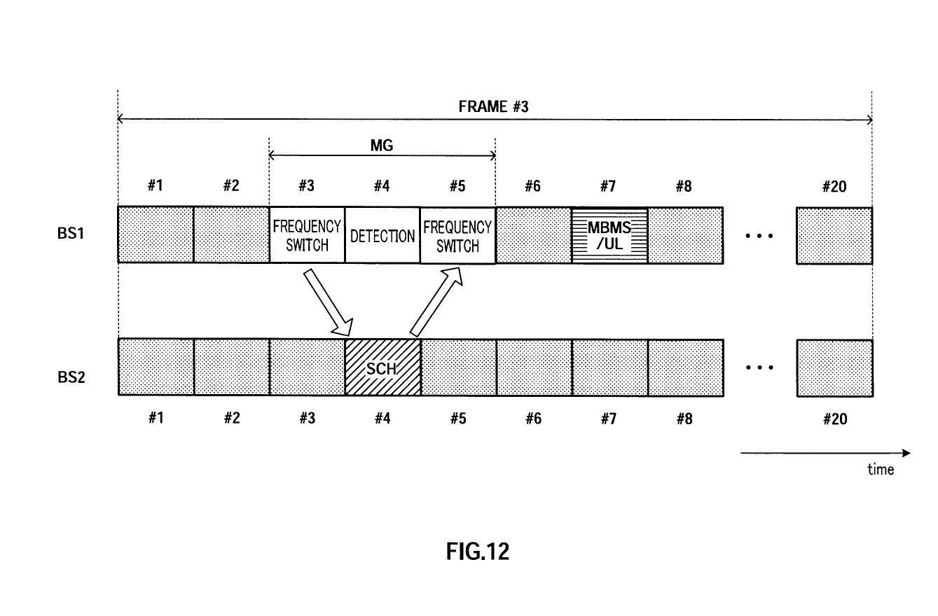

FIGS. 10 to 12 illustrate a state where SCH data having the transmission timing set as shown in FIG. 9 is detected. Here, as in a conventional manner as above, the measurement gap (MG) in base station BS1 communicating with a mobile station is set in a fixed manner in subframes #3 to #5 in all frames. Further, the subframe for MBMS data or uplink data is set in a fixed manner in only subframe #7 in all frames. Thus, the frame format of BS1 is fixed.

By contrast, as shown in FIGS. 10, 11 and 12 (corresponding to frames #1, #2 and #3 in FIG. 9), the subframe in which the transmission timing for SCH data is set in BS2 (base station 100) changes per frame, that is, the subframe in which the transmission timing for SCH data is set in BS2 moves one subframe backward every frame.

Therefore, even when the frame format of BS1 is fixed and the measurement gap does not move, a mobile station can detect SCH data for BS2 in frame #3. That is, regardless of which subframes in one frame are set in a fixed manner as the measurement gap of BS1, the mobile station can reliably detect the SCH data from BS2 per twenty frames at a maximum in the measurement gap set in the fixed position and perform a different-frequency cell search. By this means, according to the present setting example, SCH data is acquired periodically in the measurement gap set in a fixed position, so that a mobile station can quickly perform a different-frequency cell search.

Further, according to the present setting example, to enable a different-frequency cell search with respect to BS2, the measurement gap can be fixed to specific subframes without moving the measurement gap in BS1, so that a mobile station can perform a different-frequency cell search without losing the opportunity to receive MBMS data and the opportunity to transmit uplink data by setting the measurement gap in subframes other than subframes for MBMS data or subframes for uplink data.

### Setting Example 2

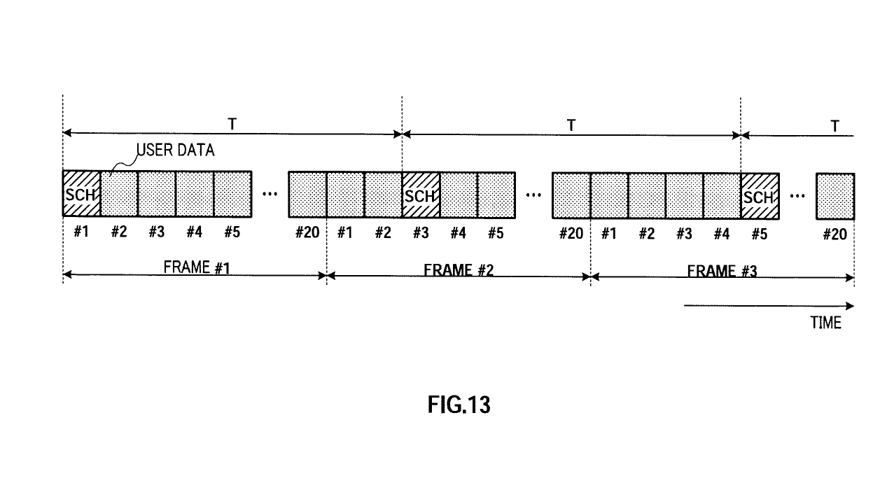

As shown in FIG. 13, transmission timing setting section 103 sets the transmission timing for SCH data in subframe #1 in frame #1, subframe #3 in frame #2 and subframe #5 in frame #3. That is, transmission timing setting section 103 moves the subframe, in which the transmission timing for SCH data is set among subframes #1 to #20, two subframes backward every frame to set the transmission timing for SCH data in only an odd-numbered subframe. With this setting, while the frame cycle is twenty subframes, transmission cycle T for SCH data is twenty-two subframes.

Here, when the transmission timing for SCH data in frame #1 is set in an even-numbered subframe (e.g., subframe #2), according to the present setting example, the transmission timing for SCH data is set in only even-numbered subframes.

Further, transmission timing setting section 103 may move the subframe, in which the transmission timing for SCH data is set, two subframes forward every frame. With this setting, while the frame cycle is twenty subframes, transmission cycle T for SCH data is eighteen subframes.

Thus, transmission timing setting section 103 sets the transmission timing for SCH data such that the transmission cycle for SCH data is N-fold a cycle coprime with one Nth of the frame cycle. As described above, when the frame cycle is twenty subframes and transmission cycle T for SCH data is twenty-two subframes, N is 2, and, as a result, one Nth of the frame cycle is ten subframes. Accordingly, if eleven subframes are used as the cycle coprime with the cycle of ten subframes, N-fold eleven subframes are twenty-two subframes.

Thus, according to the present setting example, the subframe, in which the transmission timing for SCH data is set in BS2 (base station 100), moves two subframes forward/backward every frame. Accordingly, in the example shown in FIG. 13, the transmission timing for SCH data returns to subframe #1 in frame #11. Therefore, by setting the SCH data detection period in the measurement gap of BS1 in two subframes (i.e., the measurement gap including the reception frequency switch period is four subframes), a mobile station can reliably detect SCH data from BS2 per ten frames at a maximum in the measurement gap set in the fixed position. As described above, according to the present setting example, SCH data is more likely to be found in the SCH data detection period in the measurement gap compared to above setting example 1, so that it is possible to reduce the time required for a different-frequency cell search compared to above setting example 1.

### Setting Example 3

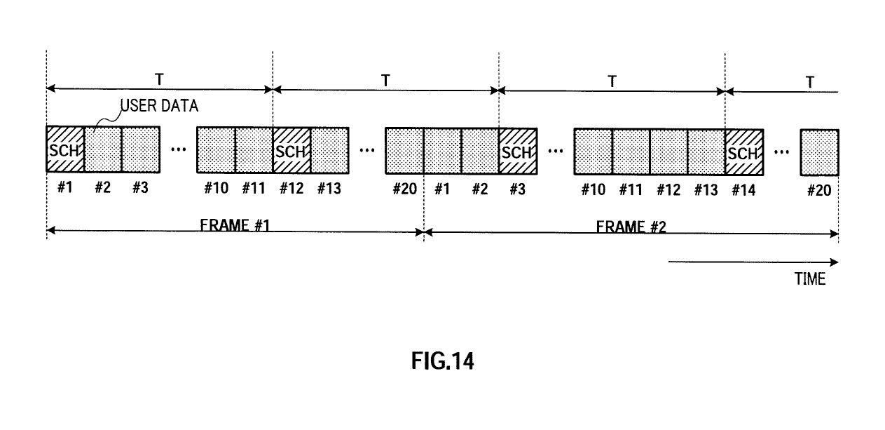

As shown in FIG. 14, transmission timing setting section 103 sets the transmission timing for SCH data in subframes #1 and #12 in frame #1 and in subframes #3 and #14 in frame #2. That is, transmission timing setting section 103 provides two subframes in which the transmission timing for SCH data is set and moves these two subframes two subframes backward every frame. With this setting, while the frame cycle is twenty subframes, transmission cycle T for SCH data is eleven subframes.

Further, transmission timing setting section 103 may move the two subframes, in which the transmission timing for SCH data is set, two subframes forward every frame. With this setting, while the frame cycle is twenty subframes, transmission cycle T for SCH data is nine subframes.

Thus, transmission timing setting section 103 sets the transmission timing for SCH data such that the transmission cycle for SCH data is coprime with one Nth (N is a natural number) of the frame cycle. As described above, when the frame cycle is twenty subframes and transmission cycle T for SCH data is eleven subframes, N is 2, and, as a result, one Nth of the frame cycle is ten subframes. Accordingly, the cycle coprime with the cycle of ten subframes is eleven subframes.

Thus, according to the present setting example, as in above setting example 2, the subframes in which the transmission timing for SCH data is set in BS2 (base station 100) moves two subframes backward/forward every frame. Further, with the present setting example, there are two subframes from which SCH data is transmitted in one frame, and these subframes are comprised of one odd-numbered subframe and one even-numbered subframe. Therefore, according to the present setting example, a mobile station can reliably detect SCH data from BS2 per ten frames at a maximum in the measurement gap set in a fixed position. Thus, according to the present setting example, as in above setting example 2, SCH data is more likely to be found in the SCH data detection period in the measurement gap compared to above setting example 1, so that it is possible to reduce the time required for a different-frequency cell search compared to above setting example 1.

As described above, according to the present embodiment, it is possible to perform SCH data transmission efficiently and perform a different-frequency cell search without losing the opportunity to perform data communication

### Embodiment 2

The base station according to the present embodiment reports the transmission timing for SCH data set in transmission timing setting section 103 to a mobile station by S-SCH.

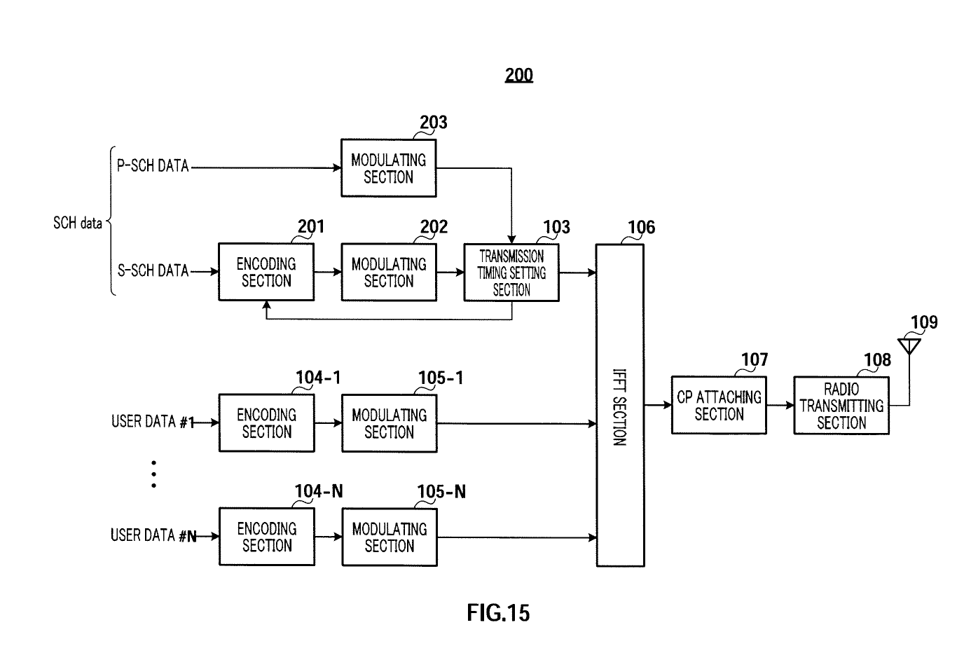

FIG. 15 illustrates a configuration of base station 200 according to the present embodiment. In FIG. 15, the same components as in Embodiment 1 (FIG. 8) will be assigned the same reference numerals and explanations thereof will be omitted.

Transmission timing setting section 103 generates data that reports the set transmission timing for SCH data to a mobile station, that is, transmission timing setting section 103 generates data that reports data showing the subframe in which the transmission timing for SCH data is set among subframes #1 to #20 (transmission timing report data), and outputs the generated data as S-SCH data to encoding section 201. That is, the transmission timing report data is transmitted by the S-SCH in the SCH. For example, the transmission timing report data is the subframe number of which SCH data is transmitted.

Further, for example, scrambling code information is inputted to encoding section 201 as S-SCH data.

Encoding section 201 encodes the S-SCH data.

Modulating section 202 modulates the encoded S-SCH data.

Further, data (P-SCH data) transmitted by P-SCH in SCH is modulated in modulating section 203.

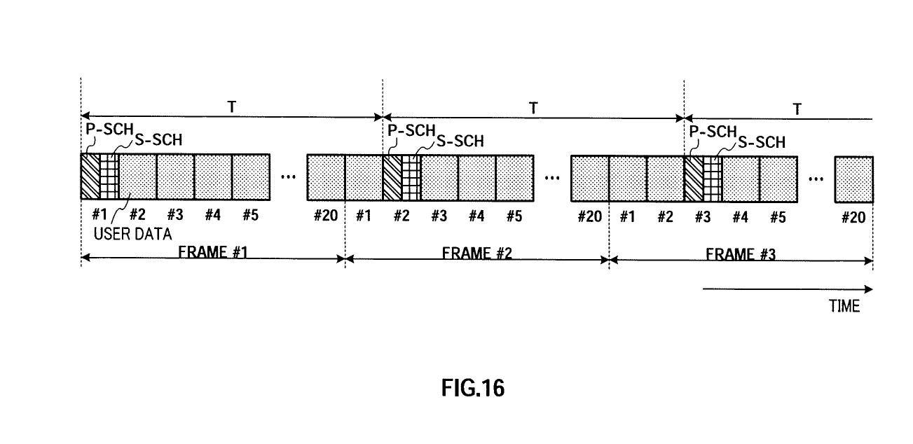

Transmission timing setting section 103 sets the transmission timing for SCH data comprised of P-SCH data and S-SCH data as in Embodiment 1. Here, the transmission timing is set as in above setting example 1. Therefore, the transmission timing for S-SCH data comprised of P-SCH data and S-SCH data is as shown in FIG. 16.

IFFT section 106 maps SCH data comprised of P-SCH data and S-SCH data, and user data #1 to #N in subcarriers #1 to #K, respectively, performs an IFFT and generates an OFDM symbol.

Here, in the example shown in FIG. 16, as transmission timing report data, subframe #1 in the S-SCH of frame #1, subframe #2 in the S-SCH of frame #2 and subframe #3 in the S-SCH of frame #3 are reported, respectively. Therefore, according to the present embodiment, a mobile station can know the frame timing during a cell search upon power activation and different-frequency cell search, so that it is possible to reduce time required for the cell search upon power activation and different-frequency cell search.

Further, although a P-SCH and an S-SCH are time-domain-multiplexed in the above example, a multiplex mode may be other modes such as frequency-domain-multiplexing.

### Embodiment 3

According to the present embodiment, the transmission cycle for SCH data is different between the FDD (Frequency Division Duplex) system and the TDD (Time Division Duplex) system.

The configuration of base station 100 according to the present embodiment is the same as in Embodiment 1 (FIG. 8). However, transmission timing setting section 103 sets the different transmission timing for SCH data between a case where base station 100 is used in the FDD system and a case where base station 100 is used in the TDD system. For example, when the FDD system is adopted to the above macro cell and the TDD system is adopted to the above micro cell, while transmission timing setting section 103 of base station 100 provided in the macro cell sets the transmission cycle for SCH data to twenty-one subframes according to above setting example 1, transmission timing setting section 103 of base station 100 provided in the micro cell sets the transmission cycle for SCH data to eleven subframes according to above setting example 2.

By this means, during a cell search upon power activation and different-frequency cell search, a mobile station can decide whether the communication mode is the FDD mode or the TDD mode, based on the transmission cycle of SCH data, and perform communication according to the communication mode of each cell.

Embodiments of the present invention have been explained above.

Here, the subframes set as the measurement gap may differ per mobile station.

Further, a base station may be referred to as “Node B,” a mobile station as “UE,” a subcarrier as a “tone,” a cyclic prefix as a “guard interval,” and a subframe as a “time slot” or simply “slot.”

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-005781, filed on Jan. 13, 2006, including the specification, drawings and abstract, is incorporated herein by reference in its entirety.

### INDUSTRIAL APPLICABILITY

The present invention is applicable to a base station in a mobile communication system.

1. A radio communication base station apparatus comprising:
a setting section that sets a transmission timing for a synchronization channel signal in one of a plurality of subframes forming a frame; and
a transmitting section that transmits the synchronization channel signal at the transmission timing set in the setting section,
wherein the setting section changes over time, a subframe in which the transmission timing is set in the plurality of subframes.

2. The radio communication base station apparatus according to claim 1, wherein the setting section periodically changes the subframe, in which the transmission timing is set in the plurality of subframes.

3. The radio communication base station apparatus according to claim 1, wherein the setting section changes every frame, the subframe in which the transmission timing is set in the plurality of subframes.

4. The radio communication base station apparatus according to claim 1, wherein the setting section sets the transmission timing such that a transmission cycle of the synchronization channel signal is coprime with a frame cycle.

5. The radio communication base station apparatus according to claim 1, wherein the setting section sets the transmission timing such that a transmission cycle of the synchronization channel signal is coprime with one Nth (N is a natural number) of a frame cycle.

6. The radio communication base station apparatus according to claim 1, wherein the setting section sets the transmission timing such that a transmission cycle of the synchronization channel signal equals to N-fold (N is a natural number) a cycle coprime with one Nth of a frame cycle.

7. The radio communication base station apparatus according to claim 1, wherein the transmitting section further transmits a report signal that reports the transmission timing set in the setting section to a radio communication mobile station apparatus.

8. The radio communication base station apparatus according to claim 7, wherein:
the synchronization channel signal is comprised of a first synchronization channel signal and a second synchronization channel signal; and
the transmitting section transmits the report signal using the second synchronization channel signal.

9. The radio communication base station apparatus according to claim 1, wherein the setting section further sets the transmission timing by changing the transmission cycle for the synchronization channel signal between a frequency division duplex system and a time division duplex system, and.

10. A synchronization channel signal transmission method that sets a transmission timing for a synchronization channel signal in one of a plurality of subframes forming a frame and transmits the synchronization channel signal at the set transmission timing, the synchronization channel signal transmission method comprising changing over time, a subframe in which the transmission timing is set in the plurality of subframes.
